(19) United States
(12) Patent Application Publication
(10) Pub. No.: US 2014/0225039 A1
(43) Pub. Date: Aug. 14, 2014

(54) RADIATION SHIELDING COMPOSITE MATERIAL INCLUDING RADIATION ABSORBING MATERIAL AND METHOD FOR PREPARING THE SAME

(71) Applicant: Industrial Technology Research Institute, Chutung (TW)

(72) Inventors: Wei-Hung Chiang, New Taipei City (TW); Shu-Jiuan Huang, Taipei City (TW); Guang-Way JANG, Hsinchu City (TW)

(73) Assignee: Industrial Technology Research Institute, Chutung (TW)

(21) Appl. No.: 14/145,703

(22) Filed: Dec. 31, 2013

Related U.S. Application Data
(60) Provisional application No. 61/763,178, filed on Feb. 11, 2013.

(51) Int. Cl. G21F 1/10; B05D 1/02; B05D 1/18; B29C 45/00

(52) U.S. Cl. CPC G21F 1/103; B29C 45/0001; B05D 1/02; B05D 1/18
USPC 252/478; 264/328.18; 427/427; 427/430.1

(57) ABSTRACT

A radiation absorbing material includes a carrier, and a heterogeneous element doped in the carrier. A content of the heterogeneous element in the carrier is higher than 15 atomic percent (at %).

### CROSS-REFERENCE TO RELATED APPLICATION

This application claims benefit of U.S. Provisional Application No. 61/763,178, filed on Feb. 11, 2013, the disclosure of which is incorporated herein by reference in its entirety.

### TECHNICAL FIELD

This disclosure relates to a radiation shielding composite material, and more particularly, to a radiation shielding composite material including a radiation absorbing material.

### BACKGROUND

Radiation is a process in which electromagnetic waves of the whole electromagnetic spectrum as well as energetic particles including atomic and subatomic particles travel through a medium. Radiation is largely classified into ionizing radiation and non-ionizing radiation. Neutron radiation is a type of ionizing radiation which consists of free neutrons. Compared to other types of ionizing radiation such as X-rays or gamma rays with a strong destructive force, neutron radiation may cause greater biological harm to the human body. Therefore, it is desirable to provide a neutron shielding material to shield against neutron radiation, in order to protect the safety of employees and the general public at sites where neutron radiation exists. In addition, neutron radiation may interfere with or damage electronic devices onboard aircraft when they are airborne and in contact with cosmic rays containing cosmogenic neutrons, resulting in the potential for a disastrous accident. Therefore, it is important to provide proper neutron shielding for electronics used in aviation applications.

Traditional means of shielding neutrons includes decelerating fast neutrons into slow thermal neutrons by using hydrogen atoms, and then absorbing the slow thermal neutrons by using neutron absorbing elements with relatively large neutron absorption cross sections. In order to effectively shield neutrons, it is desirable for a neutron shielding material to contain at least one material with a large quantity of hydrogen and at least one neutron absorbing element with a large neutron absorption cross section. The more hydrogen there is in the neutron shielding material, the stronger the deceleration effect is. Polyethylene (PE) is generally used in a neutron shielding member because it contains a relatively large amount of hydrogen. Examples of neutron absorbing elements include boron (B), lithium (Li), cadmium (Cd), iron (Fe), lead (Pd), and gadolinium (Ga). Boron (B) is a popular neutron absorbing element because it is easy to obtain.

A conventional method of forming a neutron shielding material includes blending a compound containing boron, such as boron oxide (B₂O₃) or boron carbide (B₄C), into a matrix with a high hydrogen density, to form a composite material with a high neutron shielding capability. However, in such neutron shielding material, the majority of boron atoms aggregate to form clusters having a size measured in microns. There is no individual boron atom distributed between the clusters of the boron atoms, making the neutron shielding material difficult to trap incident neutrons. Therefore, the incident neutrons may penetrate through the neutron shielding material, resulting in unsatisfactory shielding performance. Improving the performance of such a neutron shielding member may require addition of a large amount of boron compound into the matrix or increasing the thickness of the composite material. However, adding a large amount of the boron compound increases costs, and thicker shielding members may not be suitable for use in certain applications such as protective clothing or protective masks.

Recent reports show that radiation shielding members including atomic scale radiation absorbing materials in the range of nanometers may improve radiation absorption performance.

### SUMMARY

According to an embodiment of the disclosure, a radiation absorbing material is provided. The radiation absorbing material includes a carrier, and a heterogeneous element attached to the carrier. A content of the heterogeneous element in the carrier is higher than 15 atomic percent (at %).

According to another embodiment of the disclosure, a radiation shielding composite material is provided. The radiation shielding composite material includes a matrix material, and a radiation absorbing material dispersed in the matrix material.

According to still another embodiment of the disclosure, a method of preparing a radiation absorbing material is provided. The method includes adding a carrier and a heterogeneous element precursor for a heterogeneous element into a solvent, and mixing the carrier and the heterogeneous element precursor in the solvent to prepare a solution; and inducing a thermal reaction between the carrier and the heterogeneous element precursor to form the radiation absorbing material in which the carrier is doped with the heterogeneous element. The thermal reaction is carried out with a reactant gas.

According to a further embodiment of the disclosure, a method of preparing a radiation shielding composite material is provided. The method includes adding a carrier and a heterogeneous element precursor for a heterogeneous element into a solvent, and mixing the carrier and the heterogeneous element precursor in the solvent to prepare a solution; heating the solution to remove the solvent, and drying the carrier and the heterogeneous element precursor to prepare a mixed powder; inducing a thermal reaction between the carrier and the heterogeneous element precursor to form a radiation absorbing material in which the carrier is doped with the heterogeneous element, wherein the thermal reaction is carried out with a reactant gas containing an inert gas and an etching gas; mixing the radiation absorbing material with a matrix material to prepare a mixture; and processing the mixture to form the radiation shielding composite material.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments of the invention and together with the description, serve to explain principles of the invention.

FIG. 1 is a schematic illustration of a radiation shielding composite material as an exemplary embodiment.

FIG. 2 is a schematic illustration of a type of intercalation doping.

FIG. 3 is a schematic illustration of another type of intercalation doping.

FIG. 4 is a schematic illustration of substitution doping.

FIG. 5 is a flow chart illustrating a method of preparing a radiation absorbing material as an exemplary embodiment.

FIG. 6A is a schematic illustration of a mixture of carbon nanotubes and boron precursors prepared without any pretreatment, as a comparative example.

FIG. 6B is a schematic illustration of a mixture of carbon nanotubes and boron precursors prepared with a pretreatment process as an exemplary embodiment.

FIG. 7 is a schematic illustration of a reactor as an exemplary embodiment.

FIGS. 8A and 8B are graphs showing boron atomic concentrations relative to reaction temperatures measured on samples prepared with or without a pretreatment process.

FIGS. 9A and 9B are graphs showing boron atomic concentrations relative to reaction temperatures measured on samples prepared using different reactant gas.

FIG. 10 is a graph showing XPS spectra measured on samples prepared using different reactant gas.

FIG. 11 is a graph showing an EELS spectrum measured on a sample prepared according to an exemplary embodiment.

FIGS. 12A and 12B are graphs showing radiation attenuation rate (I/I₀) relative to thickness measured on different radiation shielding composite materials.

### DESCRIPTION OF THE EMBODIMENTS

Reference will now be made in detail to the present embodiments, examples of which are illustrated in the accompanying drawings. Wherever possible, the same reference numbers will be used throughout the drawings to refer to the same or like parts.

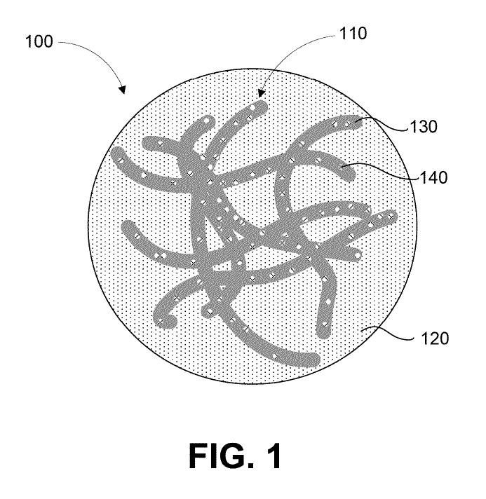

The disclosed embodiments provide a radiation shielding composite material. FIG. 1 schematically illustrates a radiation shielding composite material 100 as an exemplary embodiment. Radiation shielding composite material 100 includes a radiation absorbing material 110 dispersed inside a matrix material 120. Radiation absorbing material 110 further includes a carrier 130 and a heterogeneous element 140 doped in carrier 130.

Matrix material 120 includes polymer, ceramic material, metal, alloy, fiber, cellulose, silicon oxide (SiO2), and silicon. The polymer matrix material includes at least one of polyvinylalcohol (PVA), polyethylene (PE), high density polyethylene (HDPE), low density polyethylene (LDPE), polymethyl methacrylate (PMMA), ethylene-vinyl acetate (EVA), epoxy, and rubber. The metal matrix material includes at least one of stainless steel, aluminum (Al), titanium (Ti), zirconium (Zr), Scandium (Sc), yttrium (Y), cobalt (Co), chromium (Cr), nickel (Ni), tantalum (Ta), molybdenum (Mo), and tungsten (W).

Radiation absorbing material 110 is dispersed in matrix material 120 by homogenization methods including at least one of blending, mixing, compounding, ultrasonucation-assisted homogenization, ball milling, milling, and jet milling.

Radiation Absorbing Material

As described above, radiation absorbing material 110 includes a carrier 130 and a heterogeneous element 140 doped in carrier 130. Carrier 130 may include at least one of zero dimensional (0D), one dimensional (1D), two dimensional (2D), and three dimensional (3D) materials. Examples of 0D nano materials include carbon black and quantum dots. A 1D nano material may have a structure of nanowire, nanorod, nanotube, or nanofiber. Examples of 1D nano materials include carbon nanowire, single-walled carbon nanotube (SWCNT), double-walled carbon nanotubes (DWCNT), multi-walled carbon nanotube (MWCNT), carbon nanofiber, and any other inorganic nanowire such as silicon nanowire. The average length of the 1D nano material may be about 0.01 μm to 100 μm, and the average diameter of the 1D nano material may be about 1 nm to 100 nm. A 2D nanomaterial may have a structure of sheet, film, or plate. Examples of 2D nano materials include graphene, graphene oxide, reduced graphene oxide, diamond film, and silicon dioxide (SiO₂) film. Examples of 3D nano materials (i.e., bulk materials) include graphite, diamond, and silicon wafer. Carrier 130 may be made from at least one material of carbon (C), silicon (Si), mesoporous material, polymer, ceramics, metal, ionic salts, or any other materials. In an embodiment, heterogeneous elements can be doped in a carrier with a doping rate higher than 15 atomic percent (at %). In another embodiment, heterogeneous elements can be doped in a carrier with a doping rate higher than 25 atomic percent (at %). In still another embodiment, heterogeneous elements can be doped in a carrier with a doping rate higher than 32.15 atomic percent (at %). Heterogeneous elements can be doped in a Si system, such as SiO₂ film or Si wafer, with a doping rate higher than 10 atomic percent (at %).

Heterogeneous element 140 is a radiation absorbing element having a relatively large radiation absorption cross section. Heterogeneous element 140 may include a metal selected from a group of boron (B), lithium (Li), gadolinium (Gd), samarium (Sm), europium (Eu), cadmium (Cd), dysprosium (Dy), lead (Pb), iron (Fe), nickel (Ni), and silver (Ag). Heterogeneous element 140 may have a size in a range of about 0.05 nm to several tenths of nanometers.

In some embodiments, carrier 130 is made from carbon, and heterogeneous element 140 is boron. The molar ratio of boron to carbon in radiation absorbing material 110 may be in the range of about 0.1 to about 100. In addition, radiation absorbing material 110 may have a boron content of about 0.01 at % to about 50 at %.

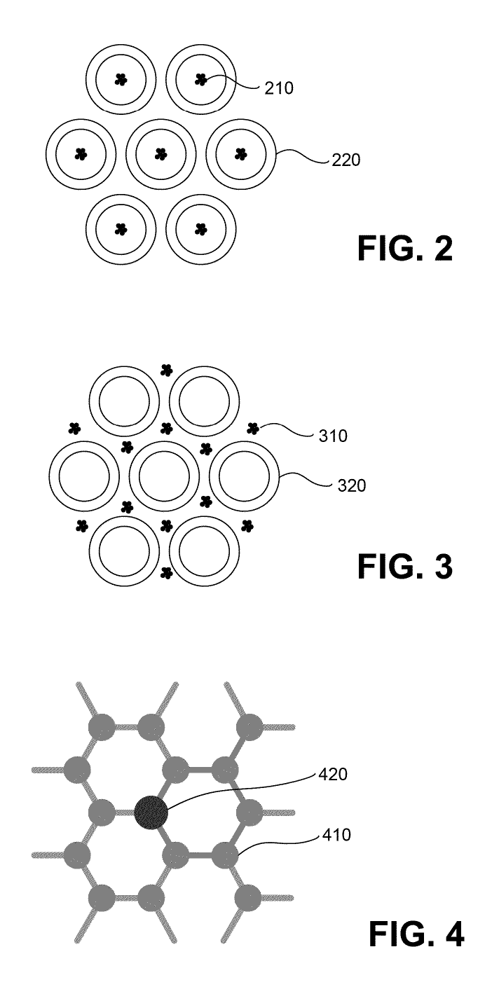

Heterogeneous element 140 may be doped in carrier 130 in two types: intercalation and substitution. Intercalation occurs when clusters of atoms of heterogeneous element 140 are trapped or inserted between layers of two-dimensional carrier 130. FIGS. 2 and 3 are top views of double wall carbon nanotubes with boron intercalation. As shown in FIG. 2, clusters 210 of boron atoms are trapped in the center of carbon nanotubes 220. As shown in FIG. 3, clusters 310 of boron atoms are inserted between layers of carbon nanotubes 320.

Substitution occurs when at least one atom of carrier 130 is replaced by an atom of heterogeneous element 140, thus forming a chemical bond between other atoms of carrier 130 and the atom of heterogeneous element 140. FIG. 4 schematically illustrates an example of carbon lattice with boron substitution. As shown in FIG. 4, one of carbon atoms 410 in the carbon nanotube lattice is substituted by a boron atom 420.

Besides doping, heterogeneous element 140 may be attached to carrier 130 by functionalization in which an atom of heterogeneous element 140 can be attached to the atoms of carrier 130. Functionalization methods include covalent bonding, non-covalent functionalization, and absorption.

In a method of covalent bonding, chemical covalent bonds are formed between an atom of heterogeneous element 140 and the atoms of carrier 130. Normally, a carrier oxidation and a subsequent redox reaction can be used for this purpose. First, a treatment of carrier 130, such as carbon nanotubes, with strong oxidizing agents such as nitric acid, KMnO₄/H₂SO₄, and oxygen gas, tends to oxidize carrier 130 and subsequently generate oxygenated functional groups on the surface of carrier 130. These oxygenated functional groups are chemically active moieties and can be used as further chemical activation sites to bond atoms of heterogeneous element 140 via a redox reaction. Hence the second step is to induce the redox reaction between reactive chemical compounds composed with atoms of heterogeneous element 140 such as salts with the oxidized carrier.

In a method of non-covalent functionalization by π-interactions, functional groups are attached to carrier 130 without disturbing an electronic network of carrier 130. When the countermolecule in heterogeneous element 140 is a metal cation in the π-interactions, a combination of electrostatic and induction energies dominate the cation-π interaction. Various kinds of receptors such as Na⁺, Ag⁺, Li⁺, and Fe²⁺ with strong binding energies and high selectivities for metal cations utilizing the cation-π interactions have been designed.

In a method of absorption, metal nanoparticles of heterogeneous element 140 are attached to carbon-based carrier 130 by direct reduction of melt precursors such as metal salts with or without reducing agents.

Method of Preparing Radiation Absorbing Material

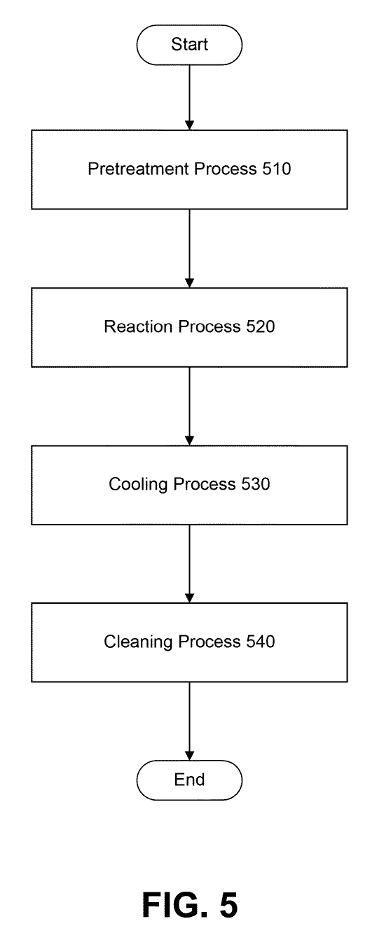

FIG. 5 is a flow chart illustrating a method of preparing radiation absorbing material 110 illustrated in FIG. 1, as an exemplary embodiment. In this example, heterogeneous element 140 is boron. In addition, in this example, carrier 130 is carbon nanotube.

When heterogeneous element 140 is boron, the boron may be made from at least one of a solid boron precursor, a liquid boron precursor, and a gaseous boron precursor. Examples of the solid boron precursor include boron oxide (B₂O₃), boron carbide (B₄C), boron nitride (BN), boric acid (H₃BO₃), and any other compound containing boron. Examples of the liquid boron precursor include aqueous solution of boric acid (H₃BO₃ (aq)), triethyl borate (C₆H₁₅BO₃), and the like. Examples of the gaseous boron precursor include triethylborane ((C₂H₅)₃B), boron trichloride (BCl₃), diborane (B₂H₆), and the like.

When the solid boron precursor is boron oxide (B₂O₃), the reaction between the boron oxide (B₂O₃) and the carbon nanotube is represented by the following equation:

xB₂O₃+(2+3x)C_{CNT}→2BₓC_{CNT}+3xCO

where C_{CNT} represents the carbon nanotube, and x is an integer larger than or equal to 0.

The process of preparing radiation absorbing material 110 begins with a pretreatment process 510 for pretreating raw materials including the solid boron precursors and pristine carbon nanotubes. The molar ratio of boron and carbon in the raw materials can be between 1 and 10. The pristine carbon nanotubes are hydrophobic and tend to bundle together due to a strong Van der Waal force. The bundling of the pristine carbon nanotubes may reduce a contact area between the carbon nanotube and the boron precursor, thus reducing a doping rate of boron in the carbon nanotubes. The purpose of pretreatment process 510 is to increase the contact area between the carbon nanotube and the boron precursor.

During pretreatment process 510, the solid boron precursors are first dissolved into a solvent. The solvent includes at least one of water, an organic solvent, and an ionic liquid. The solvent may be heated or unheated. Next, the pristine carbon nanotubes are added into the solvent. In some embodiments, before adding the carbon nanotubes into the solvent, the carbon nanotubes may be modified to become hydrophilic, increasing the contact area between the carbon nanotubes and the boron precursors. In some other embodiments, a dispersant may be added into the solvent. After the pristine carbon nanotubes are added into the solvent, the pristine carbon nanotubes and the boron precursors are mixed evenly in the solvent. The pristine carbon nanotubes and the boron precursors are mixed in the solvent by at least one mixing method of co-sonication, impregnation, and co-precipitation. Then, the solution containing the pristine carbon nanotubes and the boron precursors is heated to remove excess solvent. Last, the carbon nanotubes and the boron precursors are filtered and dried into a mixed powder.

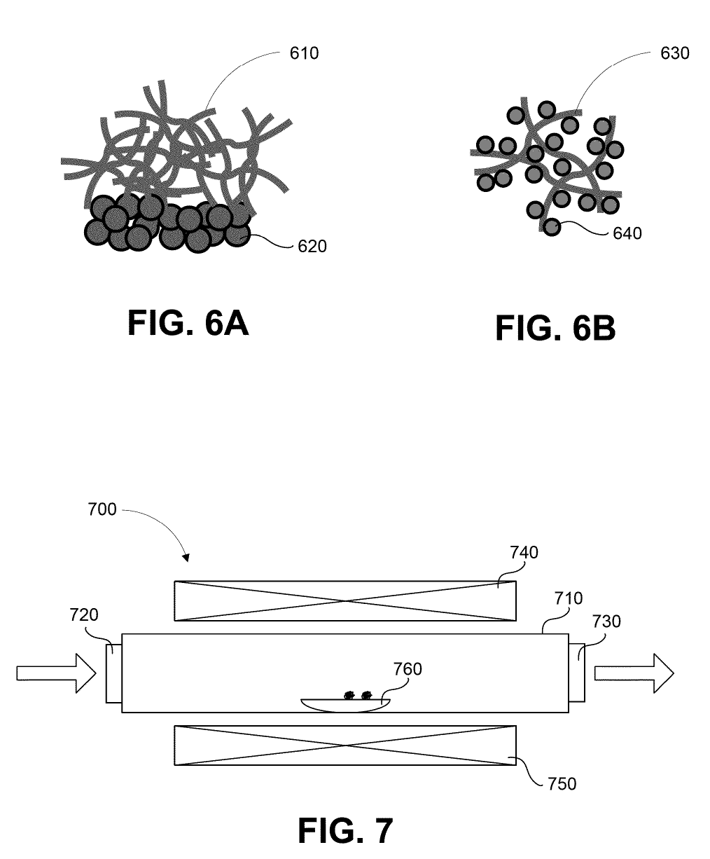

FIG. 6A schematically illustrates a mixture of carbon nanotubes 610 and boron precursors 620 prepared without any pretreatment, as a comparative example. As illustrated in FIG. 6A, carbon nanotubes 610 are bundled together, and thus boron precursors 620 are not uniformly mixed with carbon nanotubes 610. FIG. 6B schematically illustrates a mixture of carbon nanotubes 630 and boron precursor 640 prepared by pretreatment process 510. As illustrated in FIG. 6B, boron precursors 640 are uniformly dispersed between carbon nanotubes 630.

Referring back to FIG. 5, after pretreatment process 510, a reaction process 520 is performed. During reaction process 520, a carbon thermal reaction is induced between the carbon nanotubes and the boron precursors.

In some embodiments, the mixed powder of the carbon nanotubes and the boron precursors is placed in a reactor 700 as shown in FIG. 7. Reactor 700 includes a horizontal extending chamber 710 for accommodating the mixed powder, a gas supply port 720 disposed at one end of chamber 710, a gas discharge port 730 disposed at an opposite end of chamber 710, an upper heater 740 disposed at an upper side of chamber 710, and a lower heater 750 disposed at a lower side of chamber 710.

Chamber 710 may be made of alumina, and may have a diameter of about 50 mm. The mixed powder is placed in a boat 760, which is then placed inside chamber 710. Gas supply port 720 supplies a reactant gas including an inert gas and about 0 to 20% of an etching gas into chamber 710. Examples of the inert gas include argon (Ar), hydrogen (H₂), or nitrogen (N₂). Examples of the etching gas include ammonia (NH₃), or any other gas that can etch carbon nanotube. The etching gas creates vacancy defects on the crystalline lattice of the carbon nanotube, and these vacancies may be later doped with boron atoms. The element of the etching gas such as nitrogen may be doped in the carbon nanotube. Typically nitrogen and boron are both doped in the carbon nanotube with a molar ratio close to 1:1. When the carbon nanotube is doped with both boron and nitrogen, the BₓC_{y}N_{z} structure allows higher boron doping. Gas discharge port 730 discharges a reaction by-product gas generated by the carbon thermal reaction.

Upper heater 740 and lower heater 750 are configured to preheat chamber 710 from room temperature to a reaction temperature. The preheating rate may be 5° C./min. Upper heater 740 and lower heater 750 are also configured to heat chamber 710 to a reaction temperature of at least 900° C. for a predetermined period of time to allow for sufficient reaction between the carbon nanotubes and the boron precursors. In addition, the reaction is conducted at atmospheric pressure.

Referring back to FIG. 5, after reaction process 520, a cooling process 530 is performed. During cooling process 530, the product generated in reaction process 520 is cooled down to room temperature. Cooling process 530 may be performed naturally without any cooling mechanism. Alternatively, cooling process 530 may be performed by using a cooling mechanism, such as supplying a cooling gas into chamber 710.

After cooling process 530, a cleaning process 540 is performed. During cleaning process 540, the product generated in reaction process 520 is cleaned to remove unreacted raw materials. In some embodiment, the cleaning process may be omitted, because the unreacted raw materials contain boron, which still has neutron absorption properties, and thus the unreacted raw materials may be included in the radiation shielding composite material together with the radiation absorbing material. As a final product of the reaction, the radiation absorbing material in which boron is doped in the carbon nanotubes, is generated.

Radiation Shielding Composite Material

Referring back to FIG. 1, radiation shielding composite material 100 includes radiation absorbing material 110 and matrix material 120. Matrix material 120 includes at least one of polymers, ceramic materials, metals, alloys, fibers, cellulose, silicon oxide (SiO₂), and silicon. The polymer matrix material includes at least one of polyvinylalcohol (PVA), polyethylene (PE), high density polyethylene (HDPE), low density polyethylene (LDPE), polymethyl methacrylate (PMMA), epoxy, and any one or more rubber selected from the group consisting of synthetic rubber, natural rubber, silicone-based rubber and fluorine-based rubber. The metal matrix material includes at least one of stainless steel, aluminum (Al), titanium (Ti), zirconium (Zr), Scandium (Sc), yttrium (Y), cobalt (Co), chromium (Cr), nickel (Ni), tantalum (Ta), molybdenum (Mo), and tungsten (W).

In some embodiments, radiation shielding composite material 100 may also include one or more of dispersants, surfactants, rheological agents, and anti-settling agents. The content of radiation absorbing material 110 in radiation shielding composite material 100 is in the range of about 0.01 wt % to about 50 wt %. Radiation absorbing material 110 is dispersed homogeneously throughout matrix material 120 to form a network structure, increasing the performance of radiation absorption by radiation shielding composite material 100. In another embodiments, the content of radiation absorbing material 110 in radiation shielding composite material 100 is less than 20 wt %.

Radiation shielding composite material 100 may be applied as construction material for operating rooms in hospitals. In such case, radiation shielding composite material 100 may be formed in a plate shape having a thickness in the range of about 3 cm to about 5 cm. Alternatively, radiation shielding composite material 100 may be applied as a coating layer on a substance to be protected by radiation shielding composite material 100. In such case, radiation shielding composite material 100 may have a thickness in the range of about 0.01 μm to about 100 μm. Still alternatively, radiation shielding composite material 100 may be applied as a soft composite material in the form of a thin film. In such case, the thin film material made of radiation shielding composite material 100 may have a thickness in the range of about 0.01 cm to 0.1 cm.

Method of Preparing Radiation Shielding Composite Material

In one embodiment, radiation shielding composite material 100 may be prepared by mixing matrix material 120 with radiation absorbing material 110, and then thermally compressing the mixture to form radiation shielding composite material 100. The parameters of the mixing process, such as the temperature, rotational speed, and duration, can be modified to adjust the dispersion and compatibility of radiation absorbing material 110 in matrix material 120. Besides thermal compression, the mixture may be subjected to injection molding, blow molding, compression molding, extrusion, extrusion casting, laminating, foaming, coating, paste formulating, casting, fiber spinning/drawing, spraying, cell casting, and alloying to form radiation shielding composite material 100.

In another embodiment, matrix material 120 may be thermally compressed, and then radiation absorbing material 110 may be formed as a layer on at least one side of the compressed matrix material 120 by using coating, injecting, laminating, dipping, scrape-coating, or spraying.

In still another embodiment, when matrix material 120 is a metal or an alloy, radiation shielding composite material 100 may be prepared by mixing matrix material 120 with radiation absorbing material 110, and then smelting or thermally compressing the mixture to form radiation shielding composite material 100.

In some embodiments, the mixture is thermally compressed to form radiation shielding composite material 100. In addition, before processing the mixture to form the radiation shielding composite material, certain additives may be added into the mixture. The additives may include at least one of dispersants, surfactant, rheological agents, and anti-settling agents.

A further understanding of the disclosure may be obtained through the following examples, which are set forth to illustrate, but are not to be construed to limit the present invention.

### EXAMPLE 1

Preparation of Boron Doped Carbon Nanotubes

For a sample preparation without a pretreatment process, boron oxide (B₂O₃) powder and pristine multi-walled carbon nanotubes (MWCNT) are mixed together evenly to prepare a reactant. The molar ratio of boron and carbon in the reactant can be between 1 and 10. If the molar ratio of boron and carbon is less than 1, boron cannot be effectively doped in the MWCNTs. If the molar ratio is higher than 10, most boron are wasted due to insufficient MWCNTs.

For a sample preparation with a pretreatment process, the pretreatment process is conducted firstly by dissolving B₂O₃ in de-ionized water at 80° C. Then, pristine MWCNTs are slowly added into the de-ionized water to form a slurry-like solution. The molar ratio of boron and carbon in the slurry-like solution can be between 1 and 10. The solution is continuously mixed evenly using magnetic stirring at 450 rpm. Then, the solution containing the pristine MWCNT and B₂O₃ is heated to remove excess water. Last, the mixture is filtered and dried at 60° C. to prepare a reactant in the form of a mixed powder.

In both cases of preparing boron doped carbon nanotubes with and without the pretreatment process, the molar ratio of boron to carbon in the reactant is within a range from 3 to 7. The mixed reactant is then transferred to an alumina boat and a reaction takes place in a reaction chamber at a high temperature. The reaction temperature is controlled in a range from 900° C. to 1200° C. Argon or an ammonia/argon mixture is used as a reactant gas. The duration of the reaction is controlled to be 4 hours. Following the reaction, the un-reacted boron oxide is washed from the product by using hot water, and then the product is filtered and transferred to a dryer and dried at 60° C. Table 1 summarizes samples 1 through 29 prepared via different reactions having different reaction conditions.

TABLE 1

| | | Reaction | Reaction | | | |
|---|---|---|---|---|---|---|
| | B/C Molar | Temperature | Duration | Reactant | Pretreatment | B content |
| Sample | Ratio | (° C.) | (hours) | Gas | Process | (at %) |
| 1 | 3 | 900 | 4 | Ar | No | 0 |
| 2 | 3 | 1000 | 4 | Ar | No | 0.06 |
| 3 | 3 | 1100 | 4 | Ar | No | 0.14 |
| 4 | 3 | 1200 | 4 | Ar | No | 0.18 |
| 5 | 5 | 900 | 4 | Ar | No | 0 |
| 6 | 5 | 1000 | 4 | Ar | No | 0.08 |
| 7 | 5 | 1100 | 4 | Ar | No | 0.21 |
| 8 | 5 | 1200 | 4 | Ar | No | 0.4 |
| 9 | 7 | 900 | 4 | Ar | No | 0 |
| 10 | 7 | 1000 | 4 | Ar | No | 0.12 |
| 11 | 7 | 1100 | 4 | Ar | No | 0.24 |
| 12 | 7 | 1200 | 4 | Ar | No | 0.38 |
| 13 | 5 | 900 | 4 | Ar | Yes | 0 |
| 14 | 5 | 1000 | 4 | Ar | Yes | 0.56 |
| 15 | 5 | 1100 | 4 | Ar | Yes | 1.69 |
| 16 | 5 | 1200 | 4 | Ar | Yes | 2.61 |
| 17 | 5 | 1000 | 4 | 0.5% NH₃/Ar | Yes | 0.8 |
| 18 | 5 | 1100 | 4 | 0.5% NH₃/Ar | Yes | 1.23 |
| 19 | 5 | 1200 | 4 | 0.5% NH₃/Ar | Yes | 2.79 |
| 20 | 5 | 1000 | 4 | 1% NH₃/Ar | Yes | 1.96 |
| 21 | 5 | 1100 | 4 | 1% NH₃/Ar | Yes | 3.65 |
| 22 | 5 | 1200 | 4 | 1% NH₃/Ar | Yes | 6.11 |
| 23 | 5 | 1000 | 4 | 3% NH₃/Ar | Yes | 3.68 |
| 24 | 5 | 1100 | 4 | 3% NH₃/Ar | Yes | 5.63 |
| 25 | 5 | 1200 | 4 | 3% NH₃/Ar | Yes | 8.17 |
| 26 | 5 | 1000 | 4 | 10% NH₃/Ar | Yes | 10.23 |
| 27 | 5 | 1100 | 4 | 10% NH₃/Ar | Yes | 15.86 |
| 28 | 5 | 1200 | 4 | 10% NH₃/Ar | Yes | 21.14 |
| 29 | 5 | 1200 | 4 | 15% NH₃/Ar | Yes | 32.15 |

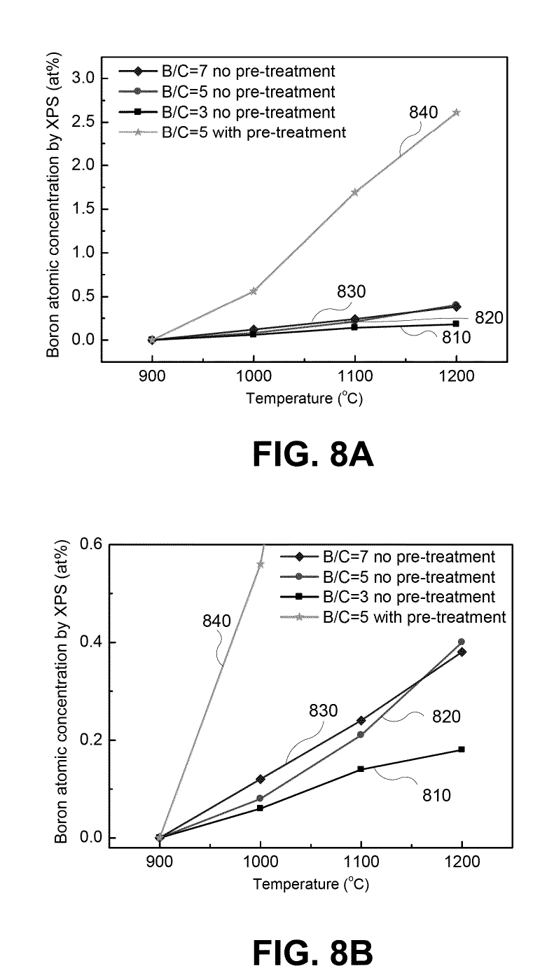

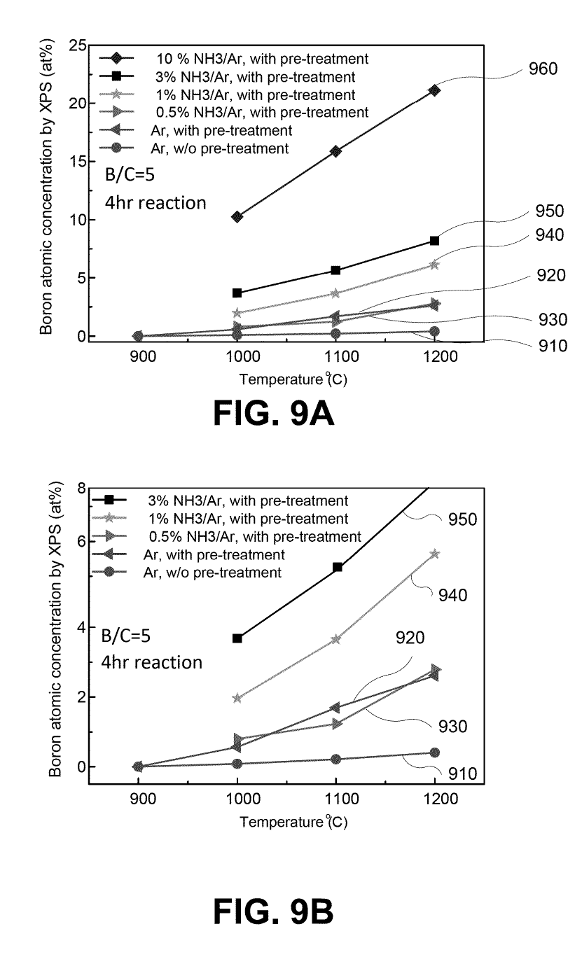

X-ray photoelectron spectroscopy (XPS) is utilized to determine the atomic concentration of boron in samples 1-29, and the results are summarized in Table 1, and shown in FIGS. 8A, 8B, 9A and 9B. FIGS. 8A and 8B are graphs showing boron atomic concentrations relative to reaction temperatures measured on samples 1 through 16, prepared with or without a pretreatment process. In FIGS. 8A and 8B, line 810 represents samples 1 through 4 prepared from reactants having a boron to carbon molar ratio of 3 and without a pretreatment process; line 820 represents samples 5 through 8 prepared from reactants having a boron to carbon molar ratio of 5 and without a pretreatment process; line 830 represents samples 9 through 12 prepared from reactants having a boron to carbon molar ratio of 7 and without a pretreatment process; and line 840 represents samples 13 through 16 prepared from reactants having a boron to carbon molar ratio of 5 and with a pretreatment process. According to FIGS. 8A and 8B, the atomic concentration of boron in samples 13-16 prepared with the pretreatment is much higher than samples 1-12 prepared without the pretreatment, even when only pure argon (Ar) is supplied during the reaction.

FIGS. 9A and 9B are graphs showing boron atomic concentrations relative to reaction temperatures measured on samples 5 through 8 and 13 through 28 prepared via reactions with or without ammonia (NH₃) as etching gas. As shown in FIGS. 9A and 9B, line 910 represents samples 5 through 8 prepared without a pretreatment process and supplied with a reactant gas containing only pure argon (Ar); line 920 represents samples 13 through 16 prepared with a pretreatment process and a reactant gas containing only pure argon (Ar); line 930 represents samples 17 through 19 prepared with a pretreatment process and a reactant gas containing argon (Ar) and 0.5% of ammonia (NH₃); line 940 represents samples 20 through 22 prepared with a pretreatment process and a reactant gas containing argon (Ar) and 1% of ammonia (NH₃); line 950 represents samples 23 through 25 prepared with a pretreatment process and a reactant gas containing argon (Ar) and 3% of ammonia (NH₃); and line 960 represents samples 26 through 28 prepared with a pretreatment process and a reactant gas containing argon (Ar) and 10% of ammonia (NH₃). According to FIGS. 9A and 9B, the presence of ammonia in the reactant gas significantly increases the boron concentration, and the higher the amount of ammonia, the higher the boron concentration can be achieved. In addition, samples 27, 28, and 29 have boron contents of above 15 at %, making them useful for neutron absorbing and shielding applications.

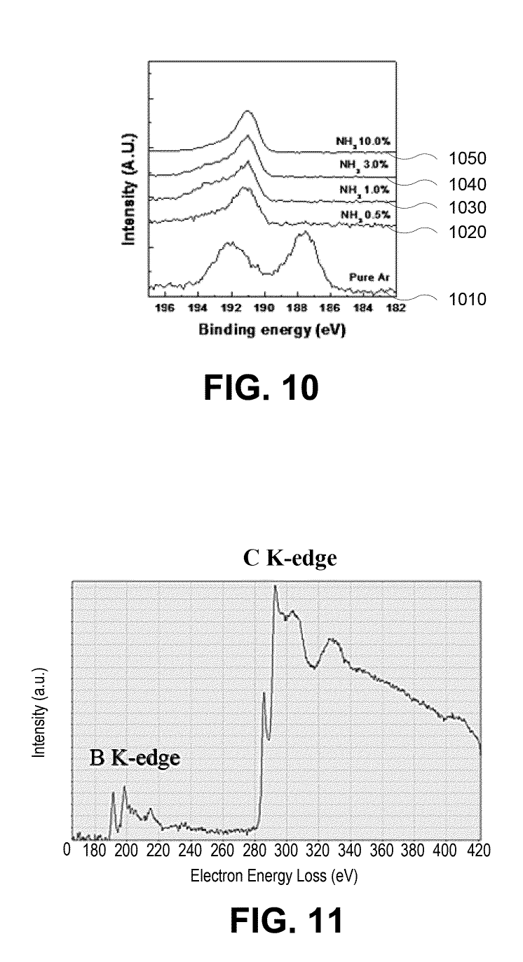

X-ray photoelectron spectroscopy (XPS) is also utilized to determine the doping type of boron in the carbon nanotubes in the samples. FIG. 10 is a graph showing XPS spectra measured on samples prepared using different reactant gas. As shown in FIG. 10, curve 1010 represents sample 16 prepared with the reactant gas containing only pure argon (Ar); curve 1020 represents sample 19 prepared with the reactant gas containing argon (Ar) and 0.5% of ammonia (NH₃); curve 1030 represents sample 22 prepared with the reactant gas containing argon (Ar) and 1% of ammonia (NH₃); curve 1040 represents sample 25 prepared with the reactant gas containing argon (Ar) and 3% of ammonia (NH₃); and curve 1050 represents sample 28 prepared with the reactant gas containing argon (Ar) and 10% of ammonia (NH₃).

Generally, the location of the peaks in XPS spectra may determine the doping type of boron in the carbon nanotube. Peaks exhibited in the binding energy range of 190 eV and 194 eV indicates that boron is doped in the carbon nanotube by substitution doping. Peaks exhibited in the binding energy range of 186 eV and 190 eV indicates that boron is doped in carbon by intercalation doping. As shown in FIG. 10, curve 1010 has a peak in the binding energy range of 190 eV and 194 eV, and a peak in the binding energy range of 186 eV and 190 eV. Therefore, in sample 16 prepared with the reactant gas containing pure argon (Ar), boron is doped in the carbon nanotube by both substitution doping and intercalation doping. On the other hand, curves 1020, 1030, 1040, and 1050 have only a peak in the binding energy range of 190 eV and 194 eV. Therefore, in samples 19, 22, 25, and 28 prepared with the reactant gas containing argon (Ar) and ammonia (NH₃), boron is doped in the carbon nanotube by only substitution doping.

Electron energy loss spectroscopy (EELS) is further utilized to determine the presence of boron substitution. FIG. 11 is a graph showing an EELS spectrum measured on sample 28. As shown in FIG. 11, the EELS spectrum includes carbon K-edge peaks at 287 eV and 295 eV and boron K-edge peaks at about 193 eV and 200 eV. The presence of the carbon K-edge peak at 287 eV and the boron K-edge peak at 193 indicates that boron is bonded to carbon within the carbon nanotube lattice, thus confirming the presence of boron substitution in sample 28.

As explained previously, intercalation occurs when clusters of boron atoms in the order of about 0.1 nm to 1 nm are inserted between layers of the carbon nanotube, and substitution occurs when at least one carbon atom of the carbon nanotube is replaced by a boron atom. Therefore, boron is dispersed more homogeneously in the carbon nanotube by substitution than by intercalation, and thus the radiation absorbing material formed by boron substitution has better radiation absorbing efficiency.

### EXAMPLE 2

Preparation of Boron Doped Nanomaterials

The preparation method is the same as Example 1, except that various carriers are used, instead of the MWCNT. Table 2 summarizes samples 30 through 35 prepared with different nanomaterials as the carriers.

TABLE 2

| | | | B/C | Reaction | Reaction | | | B |
|---|---|---|---|---|---|---|---|---|
| | | | Molar | Temperature | Duration | Reactant | Pretreatment | content |
| Sample | Carrier | Type | Ratio | (° C.) | (hours) | Gas | Process | (at %) |
| 30 | SWCNT | 1-D | 5 | 1200 | 4 | 10% NH₃/Ar | Yes | 34.84 |
| 31 | Graphite | 3-D | 5 | 1200 | 4 | 10% NH₃/Ar | Yes | 7.65 |
| | platele | | | | | | | |
| 32 | Carbon black | 0-D | 5 | 1200 | 4 | 10% NH₃/Ar | Yes | 1.3 |
| 33 | Graphene | 2-D | 5 | 1200 | 4 | 10% NH₃/Ar | Yes | 34.15 |
| | oxide | | | | | | | |
| 34 | Reduced | 2-D | 5 | 900 | 4 | 10% NH₃/Ar | Yes | 37.85 |
| | graphene | | | | | | | |
| | oxide | | | | | | | |
| 35 | MWCNT with | 1-D | 5 | 1000 | 4 | 10% NH₃/Ar | Yes | 42.45 |
| | 2400° C. | | | | | | | |
| | graphitization | | | | | | | |
| | treatment | | | | | | | |

Sample 30, 33, 34 and 35 show very high B content above 30 at %, which should be useful for neutron absorbing and shielding applications.

### EXAMPLE 3

Preparation of Radiation Shielding Composite Material Including Boron Doped Carbon Nanotube

A twin screw compounder is used to mix a polymer matrix and samples 16 and 28 prepared in Example 1, respectively, to prepare a first mixture and a second mixture. The polymer matrix is high density polyethylene (HDPE). The mixing duration is 5 minutes. The screw of the twin screw compounder rotates at 75 rpm. The mixing temperature is 180° C. The estimated weight percentage of boron in the first mixture is about 0.25%. The estimated weight percentage of boron in the second mixture is 1.44%. Each one of the first and second mixtures is then thermally compressed to form a radiation shielding composite material in the form of a plate with a thickness of 3 mm. The results are sample 36 made from sample 16, and sample 37 made from sample 28.

### EXAMPLE 4

Preparation of Boric Acid Absorbed Carbon Nanotube

A commercially available boron oxide (B₂O₃) powder is dissolved in hot water at 80° C. to form a boric acid aqueous solution. Multi-walled carbon nanotubes (MWCNT) are then mixed into the solution and the mixture is stirred continuously for 30 minutes. The molar ratio of boron oxide to carbon nanotube is 5. The heating at 80° C. is continued until the water evaporates and the mixture becomes a slurry. The slurry is then placed into a dryer and dried at 80° C. to form a dry powder. The dry powder is examined by scanning electron microscope (SEM) to ensure that there are no boron oxide particles and that only carbon tubes in a tubular structure are present. X-ray diffraction results show that boric acid (H₃BO₃) is present, and that the graphite sp2 (002) peak, the (002) peak of the product, and the pristine carbon tube (002) peak position are the same. This result confirms that there is no lattice structure of boron doped carbon tube, and thus in the product, boric acid has been absorbed to the carbon tubes.

### EXAMPLE 5

Preparation of Radiation Shielding Composite Material Including Boric Acid Absorbed Carbon Nanotube

The preparation method is the same as Example 3, except that the boric acid absorbed carbon nanotubes prepared in Example 4 is used, instead of the boron doped carbon nanotubes. The result is sample 38.

### COMPARATIVE EXAMPLE 1

Preparation of Radiation Shielding Composite Material Including Boron Oxide Particles

The preparation method is the same as Example 3, except that various amounts of boron oxide particles are used, instead of the boron doped carbon nanotubes. The boron oxide particles are 200 to 500 microns in size. The results are samples 39 and 40.

### COMPARATIVE EXAMPLE 2

Preparation of Radiation Shielding Composite Material Including Carbon Nanotubes

The preparation method is the same as Example 3, except that pure carbon nanotubes are used, instead of the boron doped carbon nanotubes. The result is sample 41.

### COMPARATIVE EXAMPLE 3

Preparation of Radiation Shielding Composite Material Including Only Matrix Material

The preparation method is the same as Example 3, except that no boron doped carbon nanotube is added. The resultant is sample 42.

Table 2 summarizes the preparation conditions for the radiation shielding composite materials (samples 36-39) prepared in Examples 2 and 5 and Comparative Example 1.

TABLE 2

| | | | | | Neutron | |
|---|---|---|---|---|---|---|
| | | | | | Absorbing | |
| | | | Neutron | | Material | |
| | Preparation | | Absorbing | | Content in | |
| Sample | Method | Reactant Gas | Material | Matrix | Matrix (wt %) | B (wt %) |
| 36 | Example 3 | Ar | B doped | HDPE | 10 | 0.25 |
| | | | MWCNT | | | |
| | | | (sample 16) | | | |
| 37 | Example 3 | 10% NH₃/Ar | B doped | HDPE | 8 | 1.44 |
| | | | MWCNT | | | |
| | | | (sample 28) | | | |
| 38 | Example 5 | — | H₃BO₃ | HDPE | 9 | 1.58 |
| | | | absorbed | | | |
| | | | MWCNT | | | |
| 39 | Comparative | — | B₂O₃ | HDPE | 10 | 3.11 |
| | Example 1 | | | | | |
| 40 | Comparative | — | B₂O₃ | HDPE | 50 | 15.55 |
| | Example 1 | | | | | |

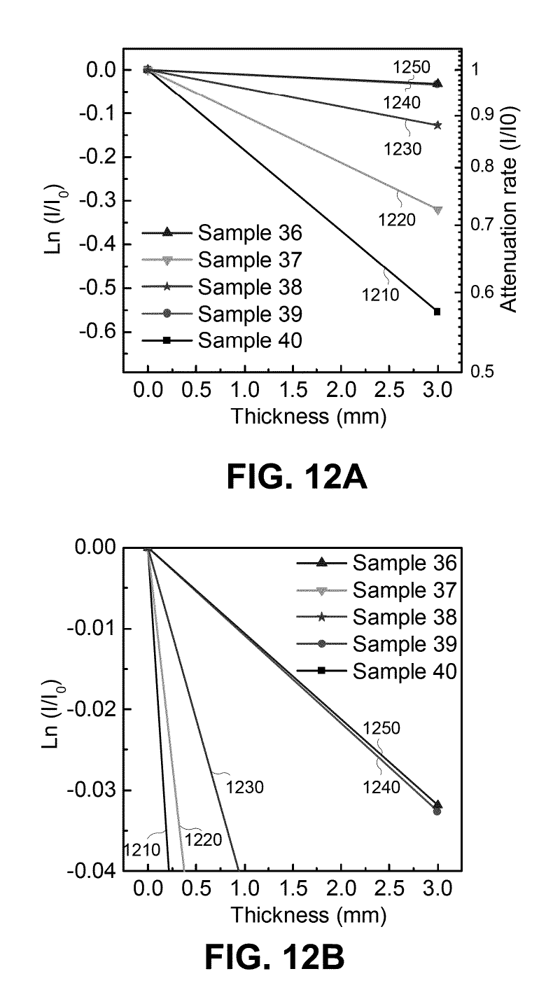

FIGS. 12A and 12B are graphs showing neutron attenuation rate (I/I₀) relative to thickness measured on samples 36 through 40. I₀ is the intensity of an input neutron flux, and I is the intensity of an output neutron flux through the composite material. Referring to FIGS. 12A and 12B, line 1210 represents sample 40, line 1220 represents sample 37, line 1230 represents sample 38, line 1240 represents sample 39, and line 1250 represents sample 36.

The neutron attenuation rate may be represented by the following equation:

$$\frac{I}{{I}_{0}} = {e}^{- {\sum }_{th}^{ } \times t}$$

wherein t is the thickness of the plate made from the composite material, and Σₜₕ is the macroscopic neutron absorption cross section. For each sample, Σₜₕ may be calculated based on the slopes of the corresponding line.

Based on macroscopic neutron absorption cross section Σₜₕ, a specific macroscopic neutron absorption cross section, specific Σₜₕ, for the composite material may be calculated according to the following equation:

$$Specific {\sum }_{th} = \frac{{\sum }_{th}}{ \begin{matrix}weight of heterogeneous \\ element in neutron absorbing material\end{matrix}}$$

The specific macroscopic neutron absorption cross section is a characteristic parameter for a specific neutron shielding material, and indicates how well the neutron shielding material can absorb neutrons. Generally, the higher the specific neutron absorption cross section of a specific neutron shielding material, the better the neutron shielding performance.

Table 3 summarizes the macroscopic neutron absorption cross sections and the specific neutron absorption cross sections of samples 36-40. According to Table 3, the radiation shielding performance of samples 36 and 37 prepared according to the embodiments of the disclosure is superior to that of samples 38, 39 and 40.

TABLE 3

| | | | | | Neutron | | | | |
|---|---|---|---|---|---|---|---|---|---|
| | | | | | Absorbing | | | | |
| | | | | | Material | | | | |
| | | | Neutron | | Content | | | | Specific |
| | Preparation | Reactant | Absorbing | | in Matrix | B | | Σₜₕ | Σₜₕ |
| Sample | Method | Gas | Material | Matrix | (wt %) | (wt %) | I/I0 | (m⁻¹) | (m⁻¹g⁻¹) |
| 36 | Example 3 | Ar | B doped | HDPE | 10 | 0.25 | 0.969 | 10.50 | 41.99 |
| | | | MWCNT | | | | | | |
| | | | (sample 16) | | | | | | |
| 37 | Example 3 | 10% NH₃/Ar | B doped | HDPE | 8 | 1.44 | 0.727 | 106.28 | 73.80 |
| | | | MWCNT | | | | | | |
| | | | (sample 28) | | | | | | |
| 38 | Example 5 | — | H₃BO₃ absorbed | HDPE | 9 | 1.58 | 0.880 | 42.61 | 26.97 |
| | | | MWCNT | | | | | | |
| 39 | Comparative | — | B₂O₃ | HDPE | 10 | 3.11 | 0.968 | 10.84 | 3.49 |
| | Example 1 | | | | | | | | |
| 40 | Comparative | — | B₂O₃ | HDPE | 50 | 15.55 | 0.575 | 184.46 | 11.86 |
| | Example 1 | | | | | | | | |

Brunauer-Emmett-Teller (BET) method is used to measure surface area of a boron doped carbon nanotube prepared according to an embodiment of the disclosure, carbon nanotube, and boron oxide. Table 4 summarizes the results of the different materials.

TABLE 4

| | Neutron Absorbing | B Doped Ratio | BET Surface Area |
|---|---|---|---|
| Sample | material | (at %) | (m²/g) |
| 36 | B doped MWCNT | 2.61 | 196.67 |
| 39 | B₂O₃ | — | <40 |
| 41 | CNT | — | 186.36 |

Generally, when the surface area of a neutron absorbing material is larger, there is an increased chance of collision between the boron atoms and the neutrons, which is favorable for capturing and absorbing the neutrons. According to Table 4, the boron doped carbon nanotube prepared according to the embodiment has a larger BET surface area than other material, and thus would have superior neutron absorbing performance.

American Society for Testing and Materials (ASTM) D638 method is used to measure mechanical properties of radiation shielding composite materials. The results are summarized in Table 5.

TABLE 5

| | | Neutron Absorbing | Tensile | Tensile |
|---|---|---|---|---|
| Sample | Matrix | material | Modules (MPa) | Strength (MPa) |
| 36 | HDPE | B doped MWCNT | 3050 | 412 |
| 39 | HDPE | B₂O₃ | 1710 | 245 |
| 41 | HDPE | CNT | 3100 | 401 |
| 42 | HDPE | — | 1500 | 264 |

Generally, the presence of carbon nanotubes improves the mechanical properties of the radiation shielding material, making it suitable as building material for operating rooms in hospitals. However, the presence of boron oxide lowers the tensile strength of the radiation shielding material. According to Table 5, the radiation shielding material includes the boron doped carbon nanotubes as the radiation absorption material, which has mechanical properties superior to those of other radiation shielding materials.

The above-described embodiments provide a radiation shielding composite material including a radiation absorbing material, and a method of preparing the radiation shielding composite material. The method allows the atoms of the radiation absorbing element (e.g., boron) to replace the carbon atoms in the surface lattice of the carbon material, and to form a stable bond with the adjacent non-substituted carbon atoms, resulting in an atomic scale radiation absorbing material.

The radiation shielding composite material prepared according to the embodiments of the present disclosure has the following advantages. First, the radiation absorbing element (e.g., boron) is distributed in its atomic state throughout the radiation shielding composite material, thus reducing the chance of radiation leakage. Second, the substitution reaction produces a stable covalent bond which increases the durability of the radiation shielding composite material. Third, the carbon carrier material features a high specific surface area which increases the chances of contact with the radiation particle (e.g., neutron), thus increasing the chance of radiation absorption by the radiation absorbing element (e.g., boron). Fourth, carbon material is pliable, and features light mass and low density, making it suitable for use in pliable radiation shielding members light in mass, thus increasing its range of applications. Fifth, the mechanical properties of carbon material are excellent, in that they enhance the mechanical properties of the radiation shielding composite material and improve durability. Sixth, carbon atoms have a light mass, and graphite is a good neutron moderating material, thus increasing the overall neutron shielding action in shielding members. Last, the surface of carbon carrier material is non-polar, and the HDPE matrix material is also non-polar, making for excellent compatibility between the two so that the dispersion of the carbon carrier material in the HDPE matrix material can be uniform.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

The radiation absorbing materials described herein can also be utilized in applications in addition to the radiation shielding applications, such as hydrogen storage applications, electrochemical sensor applications, neutron detector applications, electro materials for Li-ion battery applications, fuel cell oxygen reduction reaction applications, electro materials for supercapacitor applications, organic/oil clean up process, water purification process, catalyst support applications, scaffold support for tissue engineering and cell growth, mechanical sensor applications, materials of transparent conduction film applications, radiation hardening packaging for electronics, energy harvesting applications, building materials of nuclear medicine operation room, coatings or films for nuclear medicine therapy, and flexible/pliable/bendable materials. The radiation absorbing material may have a thickness in a range of 1 cm to 5 cm for the application of building materials of nuclear medicine operation room. The radiation absorbing material may have a thickness in a range of 0.01 μm to 10 μm for the application of coatings or films for nuclear medicine therapy. The radiation absorbing material may have a thickness in a range of 0.01 cm to 0.5 cm for the application of flexible/pliable/bendable materials.

In addition, the mechanical robustness of the radiation absorbing materials constructed according to the disclosed embodiments may be changed or altered in view of the desired application. For instance, a matrix such as polymers or metals may be used to form a composite as discussed above. In some embodiments, the radiation absorbing material may be self-sufficient for the desired application.

The examples provided herein are to more fully illustrate some of the embodiments of the present invention. It should be appreciated by those of skill in the art that the techniques disclosed in the examples above represent techniques discovered by the inventors to function well in the practice of the invention, and thus can be considered to constitute exemplary modes for its practice. However, those of skill in the art should, in light of the present disclosure, appreciate that many changes can be made in the specific embodiments that are disclosed and still obtain a like or similar result without departing from the spirit and scope of the invention.

What is claimed is:

1. A radiation absorbing material, including:
a carrier; and
a heterogeneous element doped in the carrier, and a content of the heterogeneous element in the carrier being higher than 15 atomic percent (at %).

2. The radiation absorbing material of claim 1, wherein the heterogeneous element is doped in the carrier by at least one of substitution and intercalation.

3. The radiation absorbing material of claim 1, wherein the content of the heterogeneous element in the carrier is higher than 25 at %.

4. The radiation absorbing material of claim 1, wherein the content of the heterogeneous element in the carrier is higher than 32.15 at %

5. The radiation absorbing material of claim 1, wherein the carrier includes at least one of zero dimensional (0D), one dimensional (1D), two dimensional (2D), or bulk materials.

6. The radiation absorbing material of claim 5, wherein the carrier includes at least one of carbon black, quantum dot, nanowire, nanorod, nanotube, nanofiber, multi-walled carbon nanotube (MWCNT), single-walled carbon nanotube (SWCNT), graphene, graphene oxide, reduced graphene oxide, diamond film, silicon dioxide (SiO₂) film, graphite, and silicon wafer.

7. The radiation absorbing material of claim 1, wherein the heterogeneous element include at least one of boron (B), lithium (Li), gadolinium (Gd), samarium (Sm), europium (Eu), cadmium (Cd), dysprosium (Dy), lead (Pb), and iron (Fe).

8. The radiation absorbing material of claim 1, wherein an X-ray photoelectron spectroscopy (XPS) spectrum of the radiation absorbing material has at least one peak in a binding energy range of 190 eV to 194 eV.

9. The radiation absorbing material of claim 1, wherein an X-ray photoelectron spectroscopy (XPS) spectrum of the radiation absorbing material has at least one peak in a binding energy range of 186 eV to 190 eV.

10. A radiation shielding composite material, including:
a matrix material; and
a radiation absorbing material according to any of claims 1 to 9 and dispersed in the matrix material.

11. The radiation shielding composite material of claim 10, wherein the content of the radiation absorbing material in the radiation shielding composite material is less than 20 wt %.

12. The radiation shielding composite material of claim 10, wherein the matrix material includes at least one of polymer, ceramic material, metal, alloy, fiber, cellulose, silicon oxide (SiO₂), and silicon.

13. The radiation shielding composite material of claim 12, wherein the polymer matrix material includes polyethylene (PE).

14. The radiation shielding composite material of claim 10, wherein the radiation absorbing material is dispersed in the matrix material by homogenization methods including at least one of blending, mixing, and compounding.

15. A method of preparing a radiation absorbing material, the method including:
adding a carrier and a heterogeneous element precursor for a heterogeneous element into a solvent, and mixing the carrier and the heterogeneous element precursor in the solvent to prepare a solution; and
inducing a thermal reaction between the carrier and the heterogeneous element precursor to form the radiation absorbing material in which the carrier is doped with the heterogeneous element, wherein the thermal reaction is carried out with a reactant gas.

16. The method of claim 15, wherein the reactant gas contains only an inert gas, and a doping level of the heterogeneous element in the radiation absorbing material is in a range from 0.06 at % to 0.38 at %.

17. The method of claim 15, further including heating the solution to remove the solvent, and drying the carrier and the heterogeneous element precursor to prepare a mixed powder,
wherein the reactant gas contains only an inert gas, and a doping level of the heterogeneous element in the radiation absorbing material is higher than 0.7 at %.

18. The method of claim 15, further including heating the solution to remove the solvent, and drying the carrier and the heterogeneous element precursor to prepare a mixed powder,
wherein the reactant gas contains only an inert gas, and a doping level of the heterogeneous element in the radiation absorbing material is in a range from 0.56 at % to 2.61 at %.

19. The method of claim 15, further including heating the solution to remove the solvent, and drying the carrier and the heterogeneous element precursor to prepare a mixed powder,
wherein the reactant gas contains an inert gas and more than 0.5% of an etching gas, and a doping level of the heterogeneous element in the radiation absorbing material is greater than 0.8 at %.

20. The method of claim 15, further including heating the solution to remove the solvent, and drying the carrier and the heterogeneous element precursor to prepare a mixed powder,
wherein the reactant gas contains an inert gas and more than 0.5% of an etching gas, and a doping level of the heterogeneous element in the radiation absorbing material is greater than 15 at %.

21. The method of claim 15, further including heating the solution to remove the solvent, and drying the carrier and the heterogeneous element precursor to prepare a mixed powder,
wherein the reactant gas contains an inert gas and more than 0.5% of an etching gas, and a doping level of the heterogeneous element in the radiation absorbing material is greater than 25 at %.

22. The method of claim 15, further including heating the solution to remove the solvent, and drying the carrier and the heterogeneous element precursor to prepare a mixed powder,
wherein the reactant gas contains an inert gas and more than 0.5% of an etching gas, and a doping level of the heterogeneous element in the radiation absorbing material is lower than 50 at %.

23. The method of claim 15, wherein the carrier includes at least one of carbon black, quantum dot, nanowire, nanorod, nanotube, nanofiber, multi-walled carbon nanotube (MWCNT), single-walled carbon nanotube (SWCNT), graphene, graphene oxide, reduced graphene oxide, diamond film, silicon dioxide (SiO₂) film, graphite, and silicon wafer.

24. The method of claim 15, wherein the heterogeneous element include at least one of boron (B), lithium (Li), gadolinium (Gd), samarium (Sm), europium (Eu), cadmium (Cd), dysprosium (Dy), lead (Pb), and iron (Fe)

25. The method of claim 15, wherein the heterogeneous element is boron (B), and the heterogeneous element precursor includes at least one of elemental boron (B), boron oxide (B₂O₃), boron carbide (B₄C), boron nitride (BN), boric acid (H₃BO₃), aqueous solution of boric acid (H₃BO₃ (aq)), triethyl borate (C₆H₁₅BO₃), triethylborane ((C₂H₅)₃B), boron trichloride (BCl₃), diborane (B₂H₆), and any other material containing boron.

26. The method of claim 15, further including, before adding the carrier into the solvent, modifying the surface of the carrier to become hydrophilic.

27. The method of claim 15, wherein the solvent includes water.

28. The method of claim 15, wherein the thermal reaction is carried out at atmospheric pressure and at a temperature of above 900° C.

29. The method of claim 19, wherein the etching gas includes ammonia (NH₃).

30. The method of claim 19, wherein the inert gas includes at least one of argon (Ar), hydrogen (H₂), and nitrogen (N₂).

31. A method of preparing a radiation shielding composite material, the method including:
adding a carrier and a heterogeneous element precursor for a heterogeneous element into a solvent, and mixing the carrier and the heterogeneous element precursor in the solvent to prepare a solution;
heating the solution to remove the solvent, and drying the carrier and the heterogeneous element precursor to prepare a mixed powder;
inducing a thermal reaction between the carrier and the heterogeneous element precursor to form a radiation absorbing material in which the carrier is doped with the heterogeneous element, wherein the thermal reaction is carried out with a reactant gas containing an inert gas and an etching gas;
mixing the radiation absorbing material with a matrix material to prepare a mixture; and
processing the mixture to form the radiation shielding composite material.

32. The method of claim 31, wherein the processing of the mixture includes thermally compressing, injection molding, laminating, coating, dipping, spraying, and smelting.

33. The method of claim 31, wherein the matrix material includes at least one of polymer, ceramic material, metal, alloy, fiber, cellulose, silicon oxide (SiO₂), and silicon.

34. The method of claim 33, wherein the polymer matrix material includes polyethylene (PE).
